(19) United States
(12) Patent Application Publication
(10) Pub. No.: US 2008/0184020 A1
(43) Pub. Date: Jul. 31, 2008

(54) Apparatus and method to update firmware disposed in multiple devices sharing a common address in a computing system

(75) Inventors: Lourdes Magally Gee, Tucson, AZ (US); Jason James Graves, Tucson, AZ (US); Kevan D. Holdaway, Tucson, AZ (US); David Michael Morton, Tucson, AZ (US); Ivan Ronald Olguin, Tucson, AZ (US)

Correspondence Address: DALE F. REGELMAN;QUARLES & BRADY, LLP, ONE SOUTH CHURCH AVENUE, STE. 1700, TUCSON, AZ, 85701-1621, US

(73) Assignee: International Business Machines Corporation, Armonk, NY (US)

(21) Appl. No.: 11/627,287

(22) Filed: Jan. 25, 2007

(51) Int. Cl. G06F 15/177; G06F 9/44

(52) U.S. Cl. 713/2; 717/168

(57) ABSTRACT

A method is disclosed to update firmware disposed in multiple devices sharing a common address in a computing system. The method supplies a computing system comprising a device assembly comprising a first controller, a second controller, and a communication link comprising an address and interconnecting the first controller and said second controller. The method downloads a firmware image update to the address, installs the firmware image update in one controller, and then installs the firmware image update in the other controller.

### FIELD OF THE INVENTION

This invention relates to an apparatus and method to update multiple hardware components disposed in a computing system.

### BACKGROUND OF THE INVENTION

Computing systems generate information, access information, and store information, using a plurality of hardware components, where each of those hardware components comprise one or more devices. Those devices generally comprise a processor and a firmware image comprising microcode, instructions, and the like. The processor utilizes the firmware image to operate the device.

Every so often it is necessary to update the firmware image disposed in a plurality of devices disposed in the computing system. Using prior art methods, the device being upgraded can be rendered inoperable if the firmware image update is not successfully installed. What is needed is a method to increase the reliability of a firmware image update by ensuring that the device being updated is not corrupted by an unsuccessful download of the firmware image update.

### SUMMARY OF THE INVENTION

Applicants' invention comprises a method to update firmware disposed in multiple devices sharing a common address in a computing system. The method supplies a computing system comprising an assembly having a single address in the computer system, wherein that assembly further comprises a first controller comprising a first firmware image, a first external memory interconnected with that first controller, a second controller comprising the first firmware image, a second external memory interconnected with the second controller, a first communication link comprising the address and interconnecting said first controller and said second controller, wherein that management module is in communication with the first communication link, and a second communication link interconnecting the first controller and the second controller.

The method provides a second firmware image to the address, the first controller writes the second firmware image to the first external memory and provides the second firmware image to the second controller using the second communication link. The method then writes the second firmware image to the second external memory, installs the second firmware image in the second controller, and installs the second firmware image in the first controller.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing one embodiment of Applicants' computing system;

FIG. 2 is a block diagram showing two controllers disposed in a computing device assembly;

FIG. 3 is a flow chart summarizing certain steps of Applicants' method; and

FIG. 4 is a flow chart summarizing additional steps of Applicants' method.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Applicants' invention comprises a method to update firmware disposed in multiple devices sharing a common address in a computing system. Applicants' invention is described herein in embodiments wherein a firmware image update is provided to a plurality of assemblies, wherein each of those assemblies is in communication with a management module, and wherein each of those assemblies comprises two controllers. In certain embodiments, Applicants' invention comprises a method to update firmware disposed in multiple devices disposed in a computing device assembly, wherein that computing device assembly comprises a single address in a computing system.

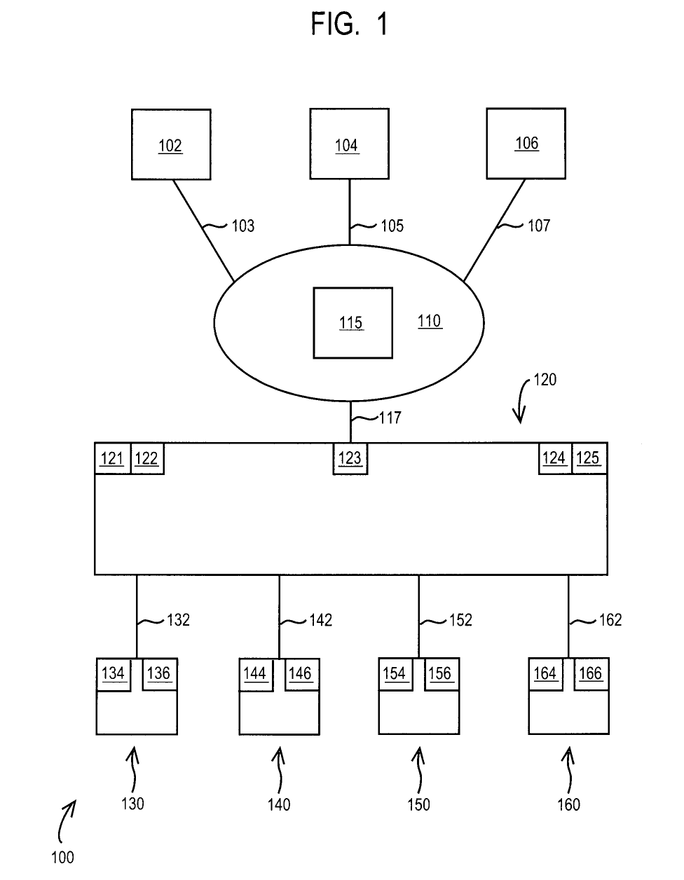

In the illustrated embodiment of FIG. 1, computing system 100 comprises management module 120 and assemblies 130, 140, 150, and 160. Further in the illustrated embodiment of FIG. 1, Applicants' management module 120 is in communication with host computers 102, 104, and 106.

In the illustrated embodiment of FIG. 1, management module 120 is interconnected with device assemblies 130, 140, 150, and 160, via communication links 132, 142, 152, and 162, respectively. In certain embodiments, Applicants' management module 120 is disposed in one of a variety of BLADECENTER computing devices sold in commerce by IBM, wherein assemblies 130, 140, 150, and 160, each comprise a device assembly, i.e. a blade, in communication with the BLADECENTER. In certain embodiments, device assemblies 130, 140, 150, and 160, may comprise one or more data storage devices.

In the illustrated embodiment of FIG. 1, device assemblies 130, 140, 150, and 160, each comprise two controllers. Device assembly 130 comprises controller 134 and controller 136. Device assembly 140 comprises controller 144 and controller 146. Device assembly 150 comprises controller 154 and controller 156. Device assembly 160 comprises controller 164 and controller 166.

As a general matter, hosts computers 102, 104, and 106, each comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald). In certain embodiments, one or more of host computers 102, 104, and/or 106, further includes a storage management program. In certain embodiments, that storage management program may include the functionality of storage management type programs known in the art that manage the transfer of data to and from a data storage and retrieval system, such as for example and without limitation the IBM DFSMS implemented in the IBM MVS operating system.

In the illustrated embodiment of FIG. 1, Applicants' management module 120 comprises memory 121, microcode 122 written to memory 121, and processor 124. Processor 124 utilizes microcode 122 to operate management module 120. In the illustrated embodiment of FIG. 1, Applicant' management module 120 further comprises data cache 125. In the illustrated embodiment of FIG. 1, management module 120 further comprises embedded web server 123. Web server 123 provides a web interface to one or more end users. In other embodiments, Applicant' management module 120 comprises a plurality of embedded web servers. In certain embodiments, a user can connect with management module 120 by opening a browser on one of host computers 102, 104, or 106, and entering in the browser the IP for the management module to log into a management module interface.

In the illustrated embodiment of FIG. 1, host computers 102, 104, and 106, are connected to fabric 110 utilizing I/O interfaces 103, 105, and 107, respectively. In certain embodiments, I/O interfaces 103, 105, and 107, may comprise any type of I/O interface, for example, Gigabit Ethernet, Ethernet, TCP/IP, iSCSI, SCSI I/O interface, and the like. In certain embodiments, host computers 102, 104, and/or 106, communicate with management module 120 via a Simplified Network Management Protocol.

In certain embodiments, fabric 110 includes, for example, one or more switches 115. In certain embodiments, those one or more switches 115 comprise one or more conventional router switches. In the illustrated embodiment of FIG. 1, one or more switches 115 interconnect host computers 102, 104, and 106, to management module 120 via I/O protocol 117. I/O protocol 117 may comprise any type of I/O interface, for example, Gigabit Ethernet, Ethernet, TCP/IP, iSCSI, SCSI I/O interface, or one or more signal lines used by switch 115 to transfer information through to and from management module 120, and subsequently assemblies 130, 140, 150, and 160.

In other embodiments, one or more host computers, such as for example and without limitation host computers 102, 104, and 106, communicate directly with management module 120 using I/O protocols 103, 105, and 107, respectively. In certain embodiments, each host computer communicates with management module 120 via a different web server.

For the sake of clarity FIG. 1 shows Applicant' management module 120 in communication with four device assemblies. In other embodiments, Applicant' data storage system 100 comprises more than four device assemblies. In the illustrated embodiment of FIG. 1, Applicant' data storage system 100 comprises one management module. In other embodiments, Applicant' data storage system 100 comprises a plurality of management modules.

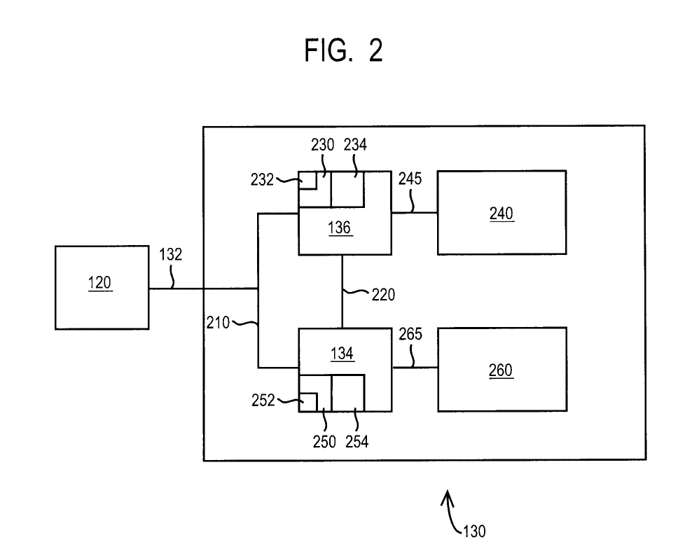

Referring now to FIG. 2, device assembly 130 comprises controller 134 and controller 136. In other embodiments, one or more of the assemblies disposed in Applicant' computing system comprise more than two controllers.

Controllers 134 and 136 are interconnected by communication bus 210, wherein communication bus 210 comprises a single address known to management module 120, and wherein communication bus 210 is in communication with communication link 132. Communication bus 210 may comprise any I/O protocol known to those skilled in the art, including for example and without limitation an RS232, RS422, RS423, or RS485 bus. Controllers 134 and 136 are interconnected by communication bus 220. Communication bus 220 may comprise any I/O protocol known to those skilled in the art, including for example and without limitation an RS232, RS422, RS423, or RS485 bus.

In the illustrated embodiment of FIG. 2, controller 134 comprises computer readable medium 250, first firmware image 252 written to computer readable medium 250, and processor 254. In certain embodiments, computer readable medium 250 comprises non-volatile memory, such as and without limitation an electronic memory device, a hard disk drive device, an optical disk drive device, battery-backed up RAM, and the like. In the illustrated embodiment of FIG. 2, controller 134 is interconnected with external memory 260 via communication link 265. In certain embodiments, memory 260 comprises non-volatile memory, such as and without limitation an electronic memory device, a hard disk drive device, an optical disk drive device, battery-backed up RAM, and the like.

In the illustrated embodiment of FIG. 2, controller 136 comprises computer readable medium 230, first firmware image 232 written to computer readable medium 230, and processor 234. In certain embodiments, computer readable medium 230 comprises non-volatile memory, such as and without limitation an electronic memory device, a hard disk drive device, an optical disk drive device, battery-backed up RAM, and the like. In the illustrated embodiment of FIG. 2, controller 136 is interconnected with external memory 240 via communication link 245. In certain embodiments, memory 240 comprises non-volatile memory, such as and without limitation an electronic memory device, a hard disk drive device, an optical disk drive device, battery-backed up RAM, and the like.

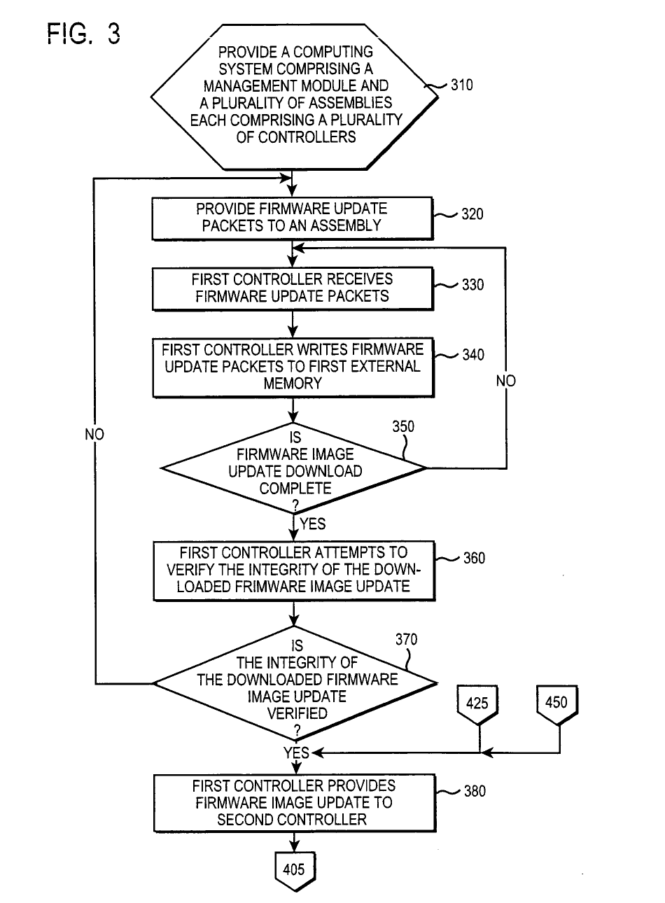

FIG. 3 summarizes the initial steps of Applicant' method to update firmware disposed in multiple devices, such as for example controllers 134 (FIGS. 1,2) and 136 (FIGS. 1,2) sharing a common address in a computing system, such as data storage system 100 (FIG. 1). Referring now to FIG. 3, in step 310 Applicant' method supplies a data storage system, such as for example and without limitation data storage system 100 (FIG. 1), comprising a management module, such as and without limitation management module 120 (FIG. 1), in communication with each of a plurality of assemblies, such as and without limitation data storage device assembly 130 (FIGS. 1, 2), wherein each of those assemblies comprises two or more controllers, such as and without limitation controller 134 (FIGS. 1, 2) and controller 136 (FIGS. 1, 2).

In step 320, Applicant' method provides a plurality of data packets comprising a firmware image update to one of the assemblies of step 310, such as for example and without limitation data storage device assembly 130 (FIGS. 1, 2). In certain embodiments, the data packets of step 320 are provided by a management module, such as and without limitation management module 120 (FIG. 1). In certain embodiments, the data packets of step 320 are provided by one or more host computers, such as one or more of host computers 102 (FIG. 1), 104 (FIG. 1), and/or 106 (FIG. 1), in communication with the data storage system of step 310.

In step 330, one of the two or more controllers, such as and without limitation controller 134 (FIGS. 1, 2), disposed in the data storage device assembly of step 320 receives the firmware image update data packets. In step 340, the receiving controller of step 330 writes the firmware image update data packets to an interconnected external memory, such as and without limitation external memory 260 (FIG. 2). In step 350, Applicant' method determines if the firmware image update download is complete. In certain embodiments, step 350 is performed by a processor, such as for example and without limitation processor 254 (FIG. 2), disposed in the receiving controller of step 330. In certain embodiments, step 350 is performed by a management module, such as and without limitation management module 120 (FIG. 1).

If Applicant' method determines in step 350 that the firmware image update download is not complete, then the method transitions from step 350 to step 330 and continues as described herein. Alternatively, if Applicant' method determines in step 350 that the firmware image update download is complete, then the method transitions from step 350 to step 360 wherein the method attempts to verify the integrity of the firmware image update. In certain embodiments, step 360 is performed by a processor, such as for example and without limitation processor 254 (FIG. 2), disposed in the receiving controller of step 330. In certain embodiments, step 360 is performed by a management module, such as and without limitation management module 120 (FIG. 1).

In step 370, Applicant' method determines if the integrity of the downloaded firmware image update could be verified. In certain embodiments, step 370 is performed by a processor, such as for example and without limitation processor 254 (FIG. 2), disposed in the receiving controller of step 330. In certain embodiments, step 370 is performed by a management module, such as and without limitation management module 120 (FIG. 1).

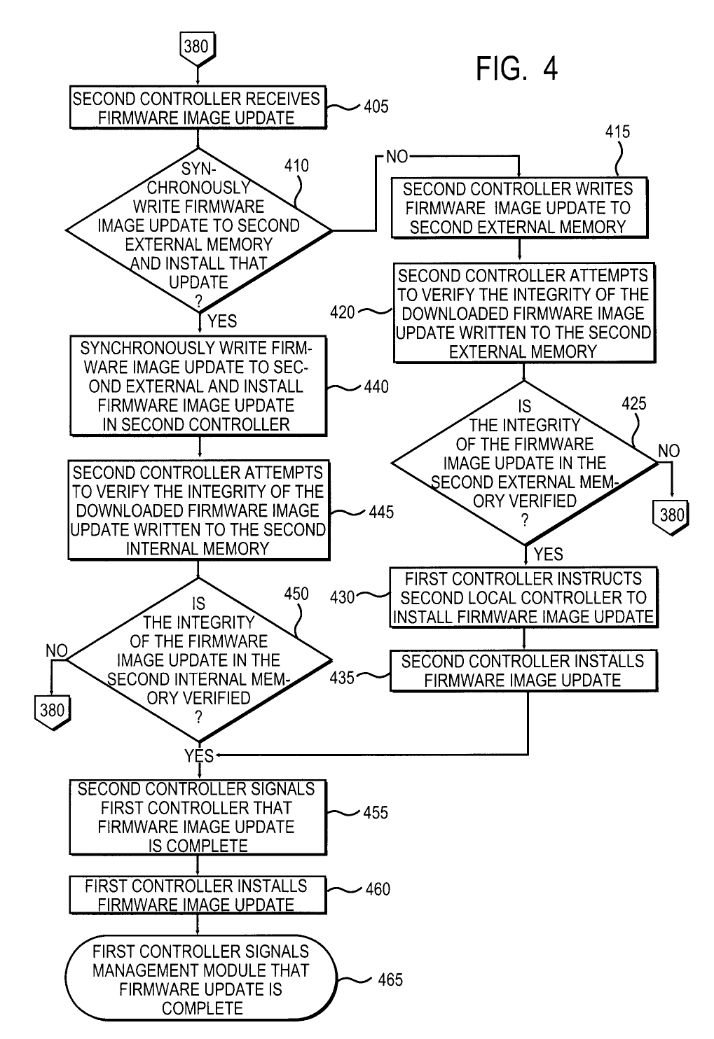

If Applicant' method determines in step 370 that the integrity of the downloaded firmware image update could not be verified, then the method transitions from step 370 to step 320 and continues as described herein. Alternatively, if Applicant' method determines in step 370 that the integrity of the downloaded firmware image update could be verified, then the method transitions from step 370 to step 380 wherein the receiving controller of step 330 provides the firmware image update to a second controller disposed in the data storage device assembly of step 320. Applicant' method transitions from step 380 to step 405 (FIG. 4).

Referring now to FIG. 4, in step 405 the second controller of step 380 receives the firmware image update. In step 410, Applicant' method determines whether to write the firmware image update to an external memory interconnected with the second controller and to synchronously install the firmware image update in that second controller. In certain embodiments, step 410 is performed by a processor disposed in the second controller. In certain embodiments, step 410 is performed by a management module, such as and without limitation management module 120 (FIG. 1). In certain embodiments, step 410 is performed by a host computer in communication with the data storage system of step 310 (FIG. 3).

If Applicant' method elects in step 410 not to synchronously write the firmware image update to an external memory interconnected with the second controller and install the firmware image update in that second controller, then the method transitions from step 410 to step 415 wherein the second controller of step 380 writes the firmware image update to an interconnected external memory, such as and without limitation external memory 240 (FIG. 2). In certain embodiments, step 415 is performed by a processor disposed in the second controller.

In step 420, Applicant' method attempts to verify the integrity of the firmware image update written to an external memory in step 415. In certain embodiments, step 420 is performed by a processor, such as for example and without limitation processor 234 (FIG. 2), disposed in the second controller, such as and without controller 136 (FIGS. 1, 2). In certain embodiments, step 420 is performed by a management module, such as and without limitation management module 120 (FIG. 1).

In step 425, Applicant' method determines if the integrity of the downloaded firmware image update written to an external memory in step 415 could be verified. In certain embodiments, step 425 is performed by a processor, such as for example and without limitation processor 234 (FIG. 2), disposed in the second controller of step 380. In certain embodiments, step 425 is performed by a management module, such as and without limitation management module 120 (FIG. 1).

If Applicant' method determines in step 425 that the integrity of the downloaded firmware image update written to an external memory in step 415 could not be verified, then the method transitions from step 425 to step 380 and continues as described herein. Alternatively, if Applicant' method determines in step 425 that the integrity of the downloaded firmware image update written to an external memory in step 415 could be verified, then the method transitions from step 425 to step 430 wherein the original receiving controller of step 330 instructs the second controller of step 380 to install the firmware image update. In certain embodiments, step 430 is performed by a processor disposed in the first controller of step 330.

In step 435, the second controller installs the firmware image update. In certain embodiments, step 435 comprises overwriting an existing firmware image, such as firmware image 232, with the firmware image update. In certain embodiments, step 435 further comprises placing the second controller in an installation mode wherein that second controller is not operational during the firmware image update installation. In certain embodiments, step 425 further comprises rebooting the second controller after installation of the firmware image update. Applicant' method transitions from step 435 to step 455.

If Applicant' method elects in step 410 to synchronously write the firmware image update to an external memory interconnected with the second controller and install that firmware image update in the second controller, then the method transitions from step 410 to step 440 wherein the method writes the firmware image update to an external memory, such as external memory 240 (FIG. 2) interconnected with the second controller, such as controller 136 (FIGS. 1, 2), and to synchronously install that firmware image update in that second controller.

In certain embodiments, step 440 comprises overwriting an existing firmware image, such as firmware image 232, with the firmware image update. In certain embodiments, step 440 further comprises placing the second controller in an installation mode wherein that second controller is not operational during the firmware image update installation. In certain embodiments, step 440 further comprises rebooting the second controller after installation of the firmware image update.

Applicant' method transitions from step 440 to step 445 wherein the method attempts to verify the integrity of the firmware image update written to an external memory in step 440. In certain embodiments, step 445 is performed by a processor, such as for example and without limitation processor 234 (FIG. 2), disposed in the second controller, such as and without controller 136 (FIGS. 1, 2). In certain embodiments, step 445 is performed by a management module, such as and without limitation management module 120 (FIG. 1).

In step 450, Applicant' method determines if the integrity of the firmware image update written to an external memory in step 440 could be verified. In certain embodiments, step 450 is performed by a processor, such as for example and without limitation processor 234 (FIG. 2), disposed in the second controller of step 380. In certain embodiments, step 450 is performed by a management module, such as and without limitation management module 120 (FIG. 1).

If Applicant' method determines in step 450 that the integrity of the firmware image update written to an external memory in step 440 could not be verified, then the method transitions from step 450 to step 380 and continues as described herein. Alternatively, if Applicant' method determines in step 450 that the integrity of the downloaded firmware image update written to an external memory in step 440 could be verified, then the method transitions from step 450 to step 455 wherein the second controller signals the first controller of step 330 that the firmware image update installation is complete. In certain embodiments, step 455 is performed by a processor disposed in the second controller.

Applicant' method transitions from step 455 to step 460 wherein the method installs the firmware image update in the first controller of step 330, such as and without limitation controller 134 (FIGS. 1, 2). In certain embodiments, step 460 comprises overwriting an existing firmware image, such as firmware image 252, with the firmware image update. In certain embodiments, step 460 further comprises placing the first controller in an installation mode wherein that first controller is not operational during the firmware image update installation. In certain embodiments, step 460 further comprises rebooting the first controller after installation of the firmware image update.

Applicant' method transitions from step 460 to step 465 wherein the first controller of step 330 signals a management module, such as management module 120 (FIG. 1), that the firmware image update for that data storage device assembly is complete. In certain embodiments, step 465 is performed by a processor, such as processor 254 (FIGS. 1, 2) disposed in the first controller.

In certain embodiments, individual steps recited in FIG. 3 and/or FIG. 4, may be combined, eliminated, or reordered.

In certain embodiments, Applicant' invention includes instructions residing in computer readable medium, such as for example memory 121 (FIG. 1) and/or computer readable medium 230 (FIG. 2) and/or computer readable medium 250 (FIG. 2), wherein those instructions are executed by a processor, such as processor 124 (FIG. 1) and/or processor 234 (FIG. 2) and/or 254 (FIG. 2), respectively, to perform one or more of steps 330, 340, 350, 360, 370, and/or 380, recited in FIG. 3, and/or one or more of steps 405, 410, 415, 420, 425, 430, 435, 440, 445, 450, 455, 460, and/or 465, recited in FIG. 4.

In other embodiments, Applicant' invention includes instructions residing in any other computer program product, where those instructions are executed by a computer external to, or internal to, system 100, to perform one or more of steps 330, 340, 350, 360, 370, and/or 380, recited in FIG. 3, and/or one or more of steps 405, 410, 415, 420, 425, 430, 435, 440, 445, 450, 455, 460, and/or 465, recited in FIG. 4. In either case, the instructions may be encoded in an information storage medium comprising, for example, a magnetic information storage medium, an optical information storage medium, an electronic information storage medium, and the like. By “electronic storage media,” Applicants mean, for example and without limitation, one or more devices, such as and without limitation, a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to update firmware disposed in multiple devices sharing a common address in a computing system, comprising the steps of:
supplying a computing system comprising an assembly comprising a single address in said computer system, said assembly further comprising a first controller comprising a first firmware image, a first external memory interconnected with said first controller, a second controller comprising said first firmware image, a second external memory interconnected with said second controller, a first communication link comprising said address and interconnecting said first controller and said second controller, and a second communication link interconnecting said first controller and said second controller;
providing a second firmware image to said address using said first communication link;
writing said second firmware image to said first external memory;
providing by said first controller said second firmware image to said second controller using said second communication link;
writing said second firmware image to said second external memory;
installing said second firmware image in said second controller; and
installing said second firmware image in said first controller.

2. The method of claim 1, wherein said providing a second firmware image step further comprises the steps of:
providing a plurality of data packets comprising said second firmware image;
receiving said plurality of data packets by said first controller;
determining by said first controller if the download of said second firmware image is complete.

3. The method of claim 2, further comprising the steps of:
determining by said first controller if the integrity of the downloaded second firmware image can be verified;
operative if the integrity of said second firmware image can be verified, providing said second firmware image to said second controller by said first controller using said second communication link.

4. The method of claim 3, further comprising the steps of:
receiving by said second controller said second firmware image;
determining whether to synchronously write said second firmware image to said second external memory and install said second firmware image in said second controller;
operative if said second firmware image is to be synchronously written to said second external memory and installed in said second controller, synchronously writing said second firmware image to said second external memory and installing said second firmware image in said second controller.

5. The method of claim 4, wherein said second controller comprises a second computer readable medium and a first firmware image written to said second computer readable medium, and wherein said installing said second firmware image in said second controller comprises the steps of:
placing said second controller in a installing mode;
overwriting said first firmware image in said second computer readable medium with said second firmware image; and
rebooting said second controller.

6. The method of claim 4, further comprising the steps of:
determining if the integrity of the second firmware image installed in said second controller can be verified;
operative if the integrity of said second firmware image installed in said second controller can be verified, providing a signal to said first controller that the second firmware image has been installed in the second controller.

7. The method of claim 4, further comprising the steps of:
operative if said second firmware image is not to be synchronously written to said second external memory and installed in said second controller, writing said second firmware image to said second external memory;
determining if the integrity of the second firmware image written to said second external memory can be verified;
operative if the integrity of said second firmware image written to said second external memory can be verified;
installing said second firmware image in said second controller;
providing a signal to said first controller that the second firmware image has been installed in the second controller.

8. The method of claim 7, wherein said second controller comprises a second computer readable medium and a first firmware image written to said second computer readable medium, wherein said installing said second firmware image in said second controller comprises the steps of:
placing said second controller in a installing mode;
overwriting said first firmware image in said second computer readable medium with said second firmware image; and
rebooting said second controller.

9. The method of claim 1, further comprising the step of receiving by said first controller a signal that the second firmware image has been installed in the second controller prior to installing said second firmware image in said first controller.

10. The method of claim 9, wherein said first controller comprises a first computer readable medium and a first firmware image written to said first computer readable medium, wherein said installing said second firmware image in said first controller comprises the steps of:
placing said first controller in a installing mode;
overwriting said first firmware image in said first computer readable medium with said second firmware image; and
rebooting said first controller.

11. The method of claim 1, wherein said supplying a computing system step further comprises supplying a computing system comprising a management module in communication with said first communication link, said method further comprising the step of:
providing by said management module said second firmware image to said address.

12. The method of claim 11, further comprising the step of, after installing said second firmware image in said first controller, providing by said first controller a signal to said management module that the second firmware installation is complete.

13. A first controller disposed in an assembly comprising a single address in a computing system, said first controller comprising a processor, a computer readable medium, a first firmware image encoded in said computer readable medium, a computer readable program code disposed in said computer readable medium, said computer readable program code being useable with said processor to receive and install a firmware image update, wherein said first controller is interconnected with an external memory, and wherein said first controller is interconnected with a second controller disposed in said assembly, the computer readable program code comprising a series of computer readable program steps to effect:
receiving a second firmware image;
writing said second firmware image to said external memory;
providing said second firmware image to said second controller disposed in said assembly;
installing said second firmware image in said first controller.

14. The first controller of claim 13, said computer readable program code further comprising a series of computer readable program steps to effect:
downloading a plurality of data packets comprising said second firmware image;
determining if the download of said second firmware image is complete;
operative if the download of said second firmware image is complete; determining if the integrity of said second firmware image can be verified;
operative if the integrity of said second firmware image can be verified, providing said second firmware image to said second controller.

15. The first controller of claim 14, said computer readable program code further comprising a series of computer readable program steps to effect:
receiving from said second controller a signal that said second firmware image has been installed in said second controller;
placing said first controller in an installing mode;
overwriting said first firmware image with said second firmware image; and
rebooting said first controller.

16. The controller of claim 15, said computer readable program code further comprising a series of computer readable program steps to effect:
receiving said second firmware image from a management module; and
after receiving said signal from said second controller, and after installing said second firmware image in said first controller, providing a signal to said management module that the second firmware installation is complete.

17. A first controller disposed in an assembly comprising a single address in a computing system, said first controller comprising a processor, a computer readable medium, a first firmware image encoded in said computer readable medium, a computer readable program code disposed in said computer readable medium, said computer readable program code being useable with said processor to receive and install a firmware image update, wherein said first controller is interconnected with an external memory, and wherein said first controller is interconnected with a second controller disposed in said assembly, the computer readable program code comprising a series of computer readable program steps to effect:
receiving a second firmware image from second controller disposed in said assembly;
determining whether to synchronously write said second firmware image to said external memory and install said second firmware image;
operative if said second firmware image is to be synchronously written to said external memory and installed in said controller, synchronously writing said second firmware image to said external memory and installing said second firmware image.

18. The first controller of claim 17, said computer readable program code further comprising a series of computer readable program steps to effect:
placing said first controller in a installing mode;
overwriting said first firmware image with said second firmware image; and
rebooting said first controller.

19. The first controller of claim 17, said computer readable program code further comprising a series of computer readable program steps to effect:
determining if the integrity of the second firmware image can be verified;
operative if the integrity of said second firmware image can be verified, providing a signal to said second that the second firmware image has been installed.

20. The first controller of claim 17, said computer readable program code further comprising a series of computer readable program steps to effect:
operative if said second firmware image is not to be synchronously written to said external memory and installed in said first controller, writing said second firmware image to said external memory;
determining if the integrity of the second firmware image can be verified;
operative if the integrity of said second firmware image can be verified;
installing said second firmware image;
providing a signal to said second controller that the second firmware image has been installed.
